(19) United States
(12) Patent Application Publication
(10) Pub. No.: US 2017/0094943 A1
(43) Pub. Date: Apr. 6, 2017

(54) ANIMAL TOY

(71) Applicant: Doskocil Manufacturing Company, Inc., Arlington, TX (US)

(72) Inventors: Chris WILSON, Arlington, TX (US); Ron BAGLEY, Arlington, TX (US)

(21) Appl. No.: 15/285,921

(22) Filed: Oct. 5, 2016

Related U.S. Application Data
(60) Provisional application No. 62/237,005, filed on Oct. 5, 2015.

(51) Int. Cl. A01K 15/02

(52) U.S. Cl. CPC A01K 15/025; A01K 15/021

(57) ABSTRACT

An animal toy includes an elongated base portion having a first end and a second end, a first wheel disposed adjacent the first end, a second wheel disposed adjacent the second end, at least one electric motor configured to drive the first wheel and the second wheel independently, a receiver configured to receive signals from a transmitter, and a controller programmed to control the electric motor and the rotational speed and direction of each of the first and second wheels.

### BACKGROUND

Field of the Invention

The present invention generally relates to an animal toy. More specifically, the present invention relates to a remote controlled dog toy that can provide interactive play between the owner and the animal.

Background Information

A long-standing practice exists for providing toys for animals. In particular, many animals, such as dogs, enjoy chasing or retrieving various types of objects such as sticks, balls, flying discs, and the like. Many breeds have an enhanced enjoyment in “playing fetch” in that such activities have been bred into such lines. Retrievers, bird dogs or gun dogs have been bred to retrieve game foul, spaniels to flush birds from the brush, and other such similar activities. Typically, such breads can be entertained by retrieving a flying disc made from a plastic material.

### SUMMARY

It has been found that a need exists for a toy that enables improved retrieving or chasing games for an animal. In particular, it has been found that a need exists for a remote controlled animal toy that enables any user to play a continuous chase game with an animal without the owner growing tired. Moreover, a need exists to improve a functional dog toy that provides interactive play between the owner and their dog

A remote controlled animal toy.

### BRIEF DESCRIPTION OF THE DRAWINGS

FIG. 1 illustrates a first embodiment of the present invention; and

FIG. 2 illustrates a second embodiment of the present invention.

### DETAILED DESCRIPTION OF EMBODIMENTS

Selected embodiments will now be explained with reference to the drawings. It will be apparent to those skilled in the art that the remote controlled animal toy improves fetch with an animal. Moreover, the remote controlled animal toy can increase playtime due to the increased movement of the toy from the electric motor.

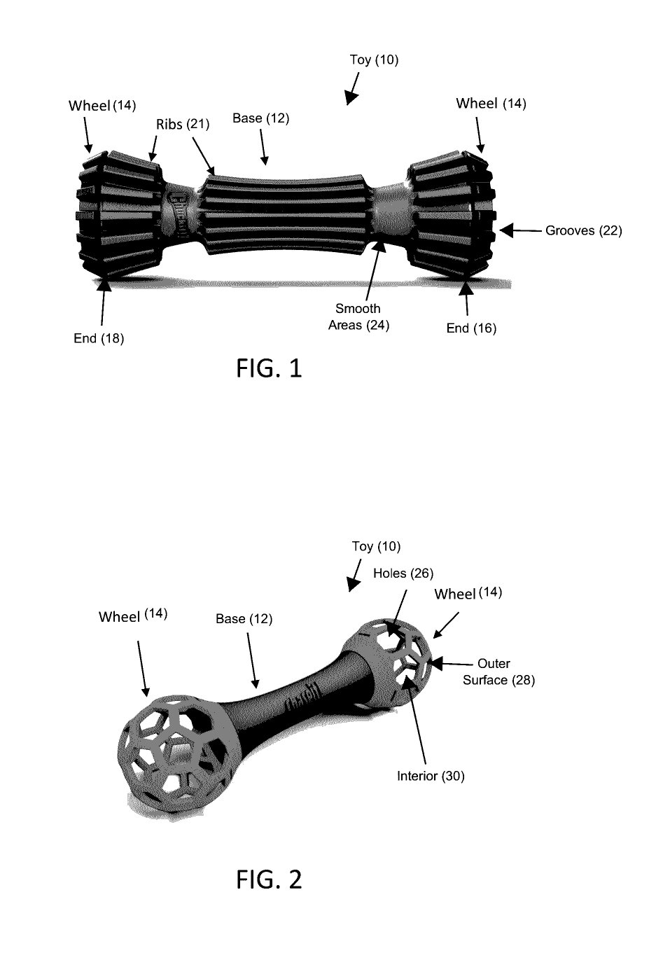

As shown in FIGS. 1 and 2, preferably the remote controlled animal toy 10 is a generally boned shaped plastic or rubber toy. However, the remote controlled animal toy can be any suitable material. Remote controlled animal toy can be designed to replicate a bone and be easy to grip for an animal.

As shown in the figures, the remote controlled animal toy includes a base 12 and at least two wheels 14. Preferably the wheels 14 are disposed on opposite ends 16,18 of the base 12. The base 12 is generally cylindrical with each of the ends having a larger diameter than the central portion 20 of the base. The base 12 is generally constructed to be rugged and durable for outdoor use, so as to be capable on driving or moving on various surfaces, such as grass other tough terrain. Moreover, the toy is water resistant or water proof so as to protect against dog slobber, rain or entry into water.

In some embodiments (e.g., FIG. 1), the base 12 can have ribs 21 or grooves 22 running in a longitudinal direction. In this embodiment, the ribs 21 or grooves 22 can extend entirely along the base 12 or have smooth areas 24 separating the grooves or ribs. In this embodiment, the smooth portions or areas 24 have a radius that is less than the height of the ribs 21.

In some embodiments (e.g., FIG. 2), the base 12 can be generally smooth or have any suitable texture thereon.

The wheels 14 are generally disposed on either end 16,18 of the base 12 and have a radius that is equal to or larger than the base 12. The wheels 14 are preferably capable of producing a large torque to enable the toy to be driven over tough terrain. This configuration gives the toy 10 a simple tank control method for movement and steering. That is, to move the toy 10 in a specific direction both wheels 14 turn at the same rate. To turn the toy 10, one wheel moves more slowly or in the opposite direction of the other wheel. This structure also enables the toy 10 to drive even if flipped over or dropped by the owner or animal. Moreover, the structure enables an animal to easily grab the base.

In some embodiments (e.g., FIG. 1), the wheels 14 have basically the same radius as the ends 16,18 of the base 12—i.e., the portions of the base 12 immediately adjacent the wheels 14. In this embodiment, the wheels 14 can also have ribs 21 thereon; however, ribs 21 are not necessarily required. In this embodiment, the wheels 14 are generally disk shaped and rotate relative to the base 12. As discussed above, the wheels 14 can rotate independently of each other to enable steering of the toy 10.

In some embodiments (e.g., FIG. 2), the wheels 14 can be generally spherically shaped, and have a radius that is larger than the ends of the base 12. Moreover, the wheels 14 can have spider webbed configuration with holes 26 in the outer surface thereof 28. Thus, the wheels 14 can be generally hollow with access to the hollow interior 30 of the wheels 14 through one or more openings or holes 26 in the surface of the wheels. Such a configuration can enable the introduction of treats inside of the wheels. The wheels 14 in this embodiment are preferably rubber allowing for a durable, bouncy structure that enables easy grip and the capability of holding treats, other toys.

The toy 10 can be remote controlled or self-propelled in any manner. Thus, in one embodiment, the toy 10 includes a motor (e.g., an electric motor) or a plurality of motors that are connected to the wheels 14 and propels the toy 10. The motors can be connected to the wheels 14 in any manner that would allow independent operation of each wheel 14 for steering purposes. For example, each wheel 14 may be driven by a motor or both wheels can be driven by a single motor and a transmission system that allows independent control and rotation of each wheel 14.

Further, the motor operation can be controller via a remote control. Such a remote control preferable can have an extended range (e.g., 200 to 300 feet), and is uses 2.4 GHz. However, the remote control can be any suitable wireless control. In is noted that the device does not necessarily need to be remote control and can merely operate using the motor in any desired manner.

Preferable, the toy 10 is powered using a rechargeable battery with water resistant charging port.

The toy 10 includes a receiver that is capable of receiving transmitted signals from a transmitter, and a controller that is programmed to control the electric motor and the rotational speed and direction of each of the first and second wheels. That is, the transmitter can transmit signals that instruct the wheels to rotate faster or slower or in opposite directions or in any manner desired. The signal is received by the receiver, which is in communication with the controller. The controller then controls the motor or motors or any transmission mechanism to operate the wheels in the manner intended by the transmitter.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claim and equivalents.

What is claimed is:

1. An animal toy comprising:
an elongated base portion having a first end and a second end;
a first wheel disposed adjacent the first end;
a second wheel disposed adjacent the second end;
at least one electric motor configured to drive the first wheel and the second wheel independently;
a receiver configured to receive signals from a transmitter; and
a controller programmed to control the electric motor and the rotational speed and direction of each of the first and second wheels.
